(19) United States
(12) Patent Application Publication
(10) Pub. No.: US 2024/0429403 A1
(43) Pub. Date: Dec. 26, 2024

(54) FLOW BATTERY STACK OR SINGLE CELL, MEMBRANE-ELECTRODE ASSEMBLY AND COMPOSITE ELECTRODE STRUCTURE THEREOF

(71) Applicant: SHANGHAI LONGVAULT ENERGY TECHNOLOGY CO., LTD., Shanghai (CN)

(72) Inventors: Zhiqi MA, Shanghai (CN); Zhijie HAN, Shanghai (CN)

(21) Appl. No.: 18/826,139

(22) Filed: Sep. 5, 2024

Related U.S. Application Data
(63) Continuation of application No. PCT/CN2023/088935, filed on Apr. 18, 2023.

(30) Foreign Application Priority Data
Mar. 11, 2022 (CN) 202210237637.7

(51) Int. Cl. H01M 4/96; H01M 4/86; H01M 4/94; H01M 8/18

(52) U.S. Cl. CPC H01M 4/96; H01M 4/8657; H01M 4/94; H01M 8/188

(57) ABSTRACT

Disclosed in the present disclosure is a flow battery stack or single cell, as well as a membrane-electrode assembly and a composite electrode structure thereof. The composite electrode is formed by compounding electrode materials which are non-uniform in direction and are of various materials into a thin asymmetric structure, using graphite felt and/or graphite fiber-based carbon paper as a foundation, and coating the outer surface layer on at least one side with a graphite powder layer, so that the specific surface area of the electrode reaction is increased, the thickness of the electrode is reduced, and the electrode activation and energy conversion efficiency is improved. The membrane-electrode assembly is configured to be an integrated packaging composite structure. Different packaging structures are designed for composite electrodes with different thicknesses, the mechanical strength is high, and the assembly performance is stable.

### TECHNICAL FIELD

The present disclosure relates to the field of new energy storage technology, specifically a rechargeable electrochemical flow battery technology, and particularly a flow battery stack or a single cell as well as a membrane-electrode assembly and a composite electrode structure thereof.

### BACKGROUND OF THE INVENTION

In recent years, with the increasing demand to improve the global natural environment by reducing the use of fossil energy and thus reducing carbon dioxide and pollutant emissions, the rapid growth of the scale of new energy power generation in order to gradually replace traditional fossil energy is irreversible. However, to compensate for the fluctuations and intermittency of new energy power generation, the demand for energy storage technology is becoming increasingly urgent. As the development of energy storage technology lags significantly behind the development of new energy power generation technology, energy storage technology has now become a bottleneck in the construction of a platform for the large-scale utilization of new energy power generation in the new generation of smart grids (or intelligent and efficient grids).

Power storage methods mainly include mechanical energy storage (such as pumped hydro storage, compressed air energy storage, thermal energy storage, ice energy storage, and flywheel energy storage), electrochemical storage (such as sodium-sulfur batteries, flow batteries, lead-acid batteries, nickel-cadmium batteries, supercapacitors, and hydrogen fuel cells), and electromagnetic storage (such as superconducting electromagnetic energy storage). When comprehensively evaluated based on indicators like energy density, efficiency, scale, cycle life, and cost, the best technology to complement the new generation of power grids is liquid-phase flow energy storage battery technology. This is due to the following advantages of liquid-phase flow energy storage batteries: (1) they have a relatively high energy storage density, reaching 10˜30 Wh/kg, and an energy conversion efficiency of 60%˜85%; (2) their power and capacity can be designed independently, with rapid charging and discharging reactions and a wide range of applications; (3) they can be used for peak shaving and valley filling, as backup power or emergency power supply, and also for improving power quality.

With the rapid development of new energy generation technology, the development and application of flow batteries have received widespread attention globally, especially in China, where flow battery projects have been prioritized and supported at both local and national levels. Currently, China has started several major flow battery projects in various regions: the 200 MW/800 MWh flow battery peak shaving power station project approved by the country in 2016, and the 100 MW/500 MWh vanadium redox flow battery energy storage project by the Hubei Green Power Vanadium New Energy Co., Ltd. of State Power Investment Corporation in 2021, indicating that the VRB technology has entered the market for large-scale energy storage power stations. In 2020, the 250 KW/1.5 MWh iron-chromium flow battery energy storage demonstration project was put into operation, marking the emergence of iron-chromium flow battery technology. Clearly, there are broader prospects for the development of flow battery technology, and it is crucial to conduct in-depth research and improvement of key technologies related to flow batteries.

The electrochemical redox reaction systems of liquid-phase flow batteries include vanadium redox batteries (VRB), sodium polysulfide-bromine (NaSx/Br) batteries, zinc-chlorine (Zn/Cl₂) or zinc-bromine (Zn/Br₂) batteries, and iron-chromium (Fe/Cr) batteries. Wherein, the VRB and Fe/Cr flow battery systems have both positive and negative electrodes in a complete liquid flow state. Compared to other solid-state batteries or single-flow batteries, they have obvious advantages of long lifespan, stable performance, low cost, flexible design, easy scalability, no geographical restrictions for construction, and safety and reliability.

Obviously, the core of a flow battery system is the (single) cell or battery stack (formed by stacking a plurality of cells). Its role is to convert electrical energy into chemical energy and store it in the electrolyte solution, and then convert the chemical energy in the electrolyte solution back into electrical energy and release it to the power grid or external load when needed. One of the most important components inside the cell or battery stack is the electrode in the positive and negative chamber. The material and structure of the electrode significantly affect the performance of the cell or battery stack, which determines the current density, and thus the power density, under a certain overpotential and voltage efficiency.

In previous flow battery technologies, the electrodes inside a single cell or battery stack mostly use a carbon felt or graphite felt material. The material properties and heat treatment temperatures of the two materials are shown in the following Table 1:

TABLE 1

| | |
|---|---|
| Carbon felt | Graphite felt |

Performance parameters

| | PAN | Rayon | PAN | Rayon |
|---|---|---|---|---|
| Bulk density | 0.14 | 0.09-0.10 | 0.1 | 0.08 |
| (g/cm³) | | | | |
| Carbon | 98.5 | 99 | >99.5 | 99.9 |
| content (%) | | | | |
| Tensile | 0.18 | 0.13 | 0.12 | 0.1 |
| strength | | | | |
| (MPa) | | | | |
| Heat | 1500 | 1400 | 2400 | 2200-2500 |
| treatment | | | | |
| temperature | | | | |
| (° C.) | | | | |

The carbon felt or graphite felt material typically has a thickness ranging from 2 to 8 mm. Taking into account the thickness of the membrane therebetween, the ion transmission distance between the positive and negative electrodes is relatively long. This results in a long path for protons and various ions to travel through the electrolyte solution. Additionally, the resistance of the proton exchange membrane contributes to the overall higher internal resistance of a single cell or battery stack, leading to increased internal resistance polarization and consequently lower voltage efficiency. Moreover, the density of the carbon felt or graphite felt material is relatively low, ranging from 0.08 to 1.2 g/cm³, with a smaller specific surface area. Furthermore, after graphitization, the fibers of the graphite felt exhibit an interwoven structure, making it relatively loose. This results in higher contact resistance between the electrode itself and the bipolar plate, leading to increased polarization of electrochemical reactions and relatively higher overpotentials. All these factors contribute to increased polarization of the battery.

Another potential electrode material is carbon paper, whose material properties and heat treatment temperature are shown in Table 2 below.

TABLE 2

| | Carbon paper |
|---|---|
| Performance | PAN |
| Bulk density (g/cm³) | 0.24 |
| Carbon content (%) | >99.75 |
| Tensile strength (MPa) | — |
| Heat treatment temperature (° C.) | >2000 |

The application of carbon paper electrodes in VRB has significantly improved the performance of flow batteries compared to carbon felt or graphite felt electrodes. Therefore, carbon paper electrodes have attracted attention and are currently being used. For example, patent CN106560944B describes a carbon (fiber) paper material preparation technology and its application in vanadium redox batteries (VRB); patents CN108346806B and CN107863536B describe the use of a carbon felt, graphite felt, carbon paper, or carbon cloth material as electrodes in the iron-chromium flow batteries; and patent CN106532069A discloses an asymmetric electrode structure in which the electrode material is a carbon felt, graphite felt, carbon paper, or carbon cloth material, but the overall thickness of the electrode material applied to a flow battery is required to be 2 mm or above.

For iron-chromium flow batteries, optimizing specific electrode material properties to reduce hydrogen evolution at the negative electrode, increasing the electrode density and specific surface area, reducing the electrode thickness while maintaining relatively low fluid resistance of the electrode, and reducing the transfer resistance of protons, ions, and other carriers are all effective means to improve the battery performance. However, such electrodes tend to have weakened mechanical strength when the thickness is reduced to 1 mm or below. Although a plurality of layers of electrodes can be laminated together to increase mechanical strength and reaction specific surface area, the fluid resistance of the electrolyte solution in the electrode becomes excessively high. This necessitates the use of the flow field bipolar plate with flow channels to reduce fluid resistance and provide the sufficient electrolyte solution, but such configurations can bring other problems.

Therefore, it is necessary to properly handle the relationship between the structure of the electrode material and the flow field structure of the bipolar plate. Designing composite electrodes and membrane-electrode assemblies with special structures, and complementing them with bipolar plates with specific flow fields would undoubtedly enhance the design, performance, and manufacturing efficiency of the cell or battery stack.

### SUMMARY OF THE INVENTION

To address the problems of the above-mentioned carbon felt, graphite felt, carbon paper in flow battery applications, as well as structural and performance problems of the flow batteries themselves, the present disclosure primarily proposes a novel electrode material and structure, the structural relationship and packaging method between the electrode material and the membrane, and the flow field structure and geometric relationship of the bipolar plate required for the electrode material, which aims to solve current problems related to electrode materials and structures, cell or battery stack structures, assembly and manufacturing, as well as the performance of the cell or battery stack in flow batteries.

To achieve the above objective, the present disclosure provides technical solutions as follows:

### Technical Solution I

A composite electrode structure is provided, and the electrode is formed by compounding electrode materials which are non-uniform in direction and are of various materials into an asymmetric structure.

Preferably, the electrode materials include graphite felt and graphite fiber-based carbon paper, the graphite felt and graphite fiber-based carbon paper being laminated.

Preferably, the electrode materials include graphite felt or graphite fiber-based carbon paper, in both sides of the graphite felt or graphite fiber-based carbon paper, an outer surface layer on at least one side is provided with a graphite powder layer, and the graphite powder layer is formed by coating deposition.

Preferably, the electrode materials include graphite felt and graphite fiber-based carbon paper, the graphite felt and graphite fiber-based carbon paper being laminated, and in both sides of a structure obtained by laminating the two, a graphite powder layer being arranged in an outer surface layer of at least one side, the graphite powder layer being formed by coating deposition.

Preferably, the graphite felt is a one-layer or multi-layer structure and the graphite fiber-based carbon paper is a one-layer or multi-layer structure.

Preferably, the graphite felt has a thickness of less than 2 mm, the graphite fiber-based carbon paper has a thickness of less than 0.4 mm, the graphite powder layer has a thickness of less than 100 μm, and a composite electrode structure has a total thickness of not greater than 2 mm.

Preferably, the composite electrode structure is treated at a high temperature ranging from 400° C. to 500° C. in the presence of oxygen.

### Technical Solution II

A membrane-electrode assembly includes a plastic frame, the composite electrode described above, an ion exchange membrane, the composite electrode described above, and a plastic frame in order in one direction, and the five are formed by thermo-compression compounding.

Preferably, for the composite electrode having a thickness of greater than 0.3 mm and less than 2 mm, a groove is formed at an inner side end of the plastic frame, an annular convex plate portion is integrally formed at an outer side end of the plastic frame, and a plurality of flow holes communicating with the groove are formed at opposite sides of the annular convex plate portion; for the composite electrode having a thickness of not greater than 0.3 mm, the plastic frame is a flat plate-type annular structure.

Preferably, an edge size of the ion exchange membrane is greater than the outer edge size of the composite electrode, the inner edge of the plastic frame is smaller than the outer edge of the composite electrode, and an outer edge size of the plastic frame is greater than the edge size of the ion exchange membrane.

Preferably, the ion exchange membrane material includes one or a combination of any of a perfluorosulfonic acid membrane, a non-perfluorosulfonic acid membrane, a hydrocarbon proton exchange membrane, a quaternized anion exchange membrane, an amphoteric ion exchange membrane with a modified polymeric material as the base material.

### Technical Solution III

A flow battery stack or single cell includes the membrane-electrode assembly described above.

Preferably, the flow battery is provided with a flow field plate or bipolar plate that is matched with the composite electrode described above, and the liquid is uniformly mirrored onto the electrode through the flow channels on the bipolar plate.

Preferably, for the composite electrode structure having a thickness of 1-2 mm, the flow field plate or bipolar plate is a partial flow field functional structure with shallow flow channels and contains an electrode slot, allowing an electrolyte fluid to partially flow through the flow channels; and for the composite electrode structure having a thickness of not greater than 1 mm, the flow field plate or bipolar plate is a full flow field functional structure with deep flow channels and does not contain an electrode slot, allowing an electrolyte fluid to wholly flow through the flow channels.

In summary, the present disclosure has the following beneficial effects:

1. The electrode material is based on graphite fiber-based carbon paper rather than other forms of carbon fiber, which reduces the hydrogen evolution side reaction in the iron-chromium flow battery, is beneficial to improving energy conversion efficiency and reducing danger in handling combustible hydrogen emissions.

2. The electrode adopts a thin asymmetric composite structure, and the multilayer porous structure has good mechanical strength and high internal porosity. This reduces fluid resistance, provides a larger reactive surface area for the redox reaction under the guaranteed reaction conditions, reduces fluid transport energy consumption, minimizes reaction polarization, and reduces energy loss, all of which contribute to improving the energy conversion efficiency of the battery system.

3. A membrane-electrode integrated packaging composite structure is adopted, and packaging structures are designed specifically for composite electrodes of different thicknesses. This provides high mechanical strength and good structural stability of the materials, thus making them less prone to damage, and easier to transport and install. The performance stability of the electrode and membrane materials and the quality stability of the cell or battery stack are improved.

4. A flow field plate or bipolar plate is used in conjunction with the membrane-electrode integrated packaging structure. The flow field plates or bipolar plates are designed specifically for composite electrodes of different thicknesses to optimize the component combination and assembly within the cell or battery stack, ensuring the performance of the cell or battery stack.

5. The theoretical maximum current density during charging and discharging of a single cell or battery stack is not less than 400 mA/cm². Under optimal conditions, the battery voltage efficiency is 84% or above, the coulombic efficiency is 99% or above, and the energy conversion efficiency of the system reaches 83% or above.

### BRIEF DESCRIPTION OF DRAWINGS

FIG. 1 is a structural schematic diagram of a composite electrode;

FIG. 2 is a structural schematic diagram of a membrane-electrode assembly;

FIG. 3 is a structural exploded diagram of the membrane-electrode assembly;

FIG. 4 is a structural schematic diagram of a plastic frame from one perspective;

FIG. 5 is an enlarged diagram of the plastic frame at A of FIG. 4;

FIG. 6 is a structural schematic diagram of the plastic frame from another perspective;

FIG. 7 is an enlarged diagram of the plastic frame at B of FIG. 6;

FIG. 8 is a bipolar plate with a partial flow field function for a membrane-electrode assembly with 1-2 mm thick electrodes (an inlet and an outlet are connected to a flow-restricting channel which is located on the back of the flow field plate);

FIG. 9 is a structural exploded diagram of the bipolar plate from one perspective;

FIG. 10 is a structural exploded diagram of the bipolar plate from another perspective;

FIG. 11 is an embedded flow field plate, (a) a flow field plate embedded into a plastic plate frame with a shared channel, (b) an exploded diagram showing the plastic frame with the shared channel and the flow-restricting channel in the front, and the flow field plate with a serpentine cross-flow field at the back;

FIG. 12 is the combination of a membrane-electrode assembly employing an electrode having a thickness of 1-2 mm and a bipolar plate;

FIG. 13 is a structural schematic diagram of a battery stack with three cells; and

FIG. 14 is a bipolar plate with a full flow field function for use with a membrane-electrode assembly employing an electrode having a thickness of not greater than 1 mm.

### REFERENCE SIGNS

1, plastic frame; 2. composite electrode; 3. ion exchange membrane; 4. opening; 5. groove; 6. annular convex plate portion; 7. flow hole; 8. first polar plate; 9. second polar plate; 10. first electrode slot; 11. first flow channel; 12. flow field electrolyte outlet; 13. first drainage hole; 14. electrolyte outlet shared through hole; 15. first guide channel; 16. flow field electrolyte inlet; 17. second drainage hole; 18. electrolyte inlet shared through hole; 19. second guide channel; 20. first through hole; 21. second through hole; 22. end plate; 23. current collecting plate; 24. end flow field plate; 25. inlet/outlet connector; 26. bipolar plate; 27. membrane-electrode assembly.

### DETAILED DESCRIPTION OF THE INVENTION

For some technical terms of the present disclosure, the following explanations are made:

A “symmetric electrode” refers to an electrode material that is uniform and consistent in direction, the material is the same, and other parameters such as pore size, porosity, density, specific surface area, etc., are also identical, it is typically the same kind of material. An “asymmetric electrode” refers to an electrode material that is not uniform in itself and is not made of a single material. For example, its pore size, porosity, density, specific surface area, and other parameters may vary, it can be a composite structure of several materials, or a multi-pore structure, or the specific surface area varies from layer to layer. Different materials can be freely combined into two, three, or more layers.

A “symmetric electrode combination” refers to the use of the same electrode material on both sides of the membrane. Conversely, the use of different materials or structures for the positive and negative electrodes constitutes an “asymmetric electrode combination”. The asymmetric electrode combination structure can be prepared beforehand or temporarily created during the operation process through specific methods. The design intention of the asymmetric electrode combination is to increase electrode activity, reduce mass transfer resistance, minimize the polarization degree of electrode reactions, improve reversibility, enhance the efficiency of electrode reactions, as well as charge-discharge conversion efficiency. It also includes reducing or inhibiting side reactions and minimizing energy losses.

For the iron-chromium flow battery, the negative electrode reaction upon charging is

$${Cr}^{3 +} + {e}^{-} {\to }^{Charging} {Cr}^{2 +}$$

When the electrochemical reaction polarization is large, the reverse reaction is ignored, and the relationship between the overpotential and current density satisfies the Tafel equation,

$$i = {i}_{0} [ \frac{{C}_{{Cr}^{2 +}} ( 0 , t )}{\text{?}} ] exp [ \frac{( 1 - α )}{RT} η ] \qquad ( 1 )$$

$$\text{?} \text{indicates text missing or illegible when filed}$$

and i₀ is the exchange current. For a single electron reaction, the magnitude of exchange current density is calculated as follows:

$${i}_{0} = {Fk}^{0} {C}_{{Cr}^{3 +}}^{* ( 1 - α )} {C}_{{Cr}^{2 +}}^{* α} \qquad ( 2 )$$

$${k}^{0} = δγ {A}_{S} \text{?} \qquad ( 3 )$$

$$i = F δ γ {A}_{S} \text{?} [ {C}_{{Cr}^{2 +}} ( 0 , t ) {( \frac{{C}_{{Cr}^{3 +}}^{*}}{{C}_{{Cr}^{2 +}}^{*}} )}^{( 1 - α )} ] exp [ \frac{( 1 - α ) F}{RT} η ]$$

$$\text{?} \text{indicates text missing or illegible when filed}$$

In the above equations (1), (2), and (3),
η is the overpotential, with the unit of V;
i is the current density per unit apparent geometric area on the porous electrode, with the unit of A/cm²;
i₀ is the exchange current density per unit apparent geometric area on the porous electrode, with the unit of A/cm²;
F is the Faraday's constant, 96485.34 C/mol;
α is the transfer coefficient, typically in the range of 0.5 to 1; for the Fe³⁺/Fe²⁺ reaction, α=0.59 is taken here; for the Cr³⁺/Cr²⁺ reaction, α=0.5 is taken here;
Aₛ is the specific surface area of the porous electrode, with the unit of cm²/g;
γ is the apparent bulk density of the porous electrode material, with the unit of g/cm³;
δ is the thickness of the porous electrode, with the unit of cm;
k⁰ is the reaction rate coefficient per unit geometric area of the porous electrode, with the unit of cm/s;
k′ is the reaction rate coefficient per unit mass specific surface area of the porous electrode, with the unit of cm/s;
C*_{Cr3+} and C*_{Cr2+} are the concentrations of an oxidation reactant Cr³⁺ and a reduction reactant Cr²⁺ on the porous electrode void surface, respectively, with the unit of mol/l;
C_{Cr2+}(0, t) is the concentration of the reduction reactant Cr²⁺ in the main electrolyte solution at time t, with the unit of mol/l;
R is the universal gas constant, 8.3143 J/mol·K; and
T is the absolute temperature, K, of the electrochemical reaction at the electrode.

Moreover, the magnitude of the overpotential η may take into account the contribution of several aspects:

$$η = ( E - {E}^{0} ) + i ( {R}_{e} + {R}_{m} + {R}_{c} ) \qquad ( 4 )$$

Wherein, (E−E⁰) is the reactive polarization overpotential;
Rₑ, Rₘ, R_{c} are the internal resistance of proton transport in the electrolyte solution, the internal resistance of the membrane material, and the contact resistance between the electrode and the polar plate, respectively, and the combination of the three is the linear internal resistance of the battery, and the unit is Ω cm².

From equations (1), (2), (3), and (4), it can be concluded that under the condition of fixed physical properties of electrode materials, one of the main measures to improve the performance of a single cell or battery stack of a flow battery is to enhance the electrode activity. Increasing the specific surface area of electrode reactions and reducing the electrode thickness are important ways to improve electrode activity. Meanwhile, it is necessary to ensure that the fluid resistance or mass transfer resistance in the porous electrode does not increase significantly, and the contact resistance between the electrode and the flow field plate is reduced.

To this end, the present disclosure provides a composite electrode structure, a membrane-electrode assembly employing the composite electrode structure, a flow battery stack or a single cell employing the membrane-electrode assembly. The disclosure will now be further described with reference to the accompanying drawings.

### Embodiment 1: A Composite Electrode Structure

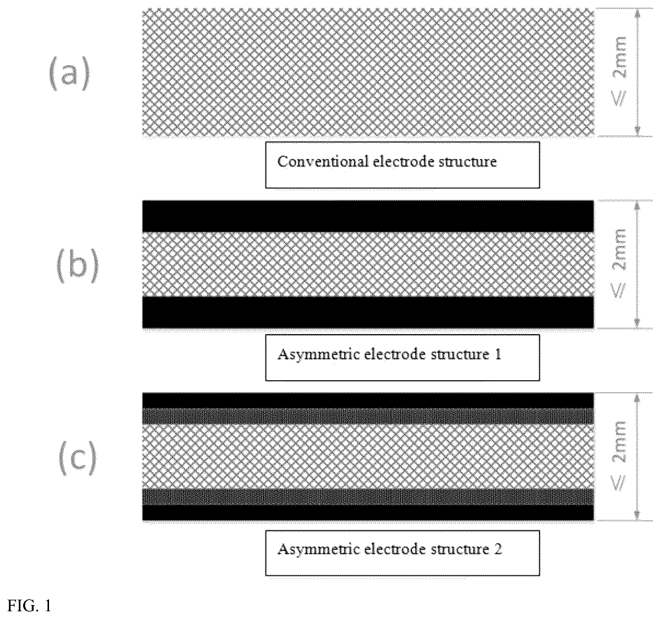

FIG. 1 (a) is a conventional electrode made of a graphite felt material, which is a symmetric electrode due to the single material and uniform structure.

FIGS. 1 (b) and 1 (c) are a new composite electrode structure based on graphite fibers proposed in the present disclosure, which is formed by compounding electrode materials which are non-uniform in direction and are of various materials into a thin asymmetric structure. FIG. 1(b) shows a layer of graphite fiber-based carbon paper (with a thickness of less than 1 mm) superimposed on each of two sides of the graphite felt material (with a thickness of not greater than 2 mm) shown in FIG. 1(a). FIG. 1(c) depicts the further deposition of graphite powder (with a thickness not exceeding 200 μm) sprayed onto both sides of the graphite fiber-based carbon paper based on FIG. 1(b).

This disclosure employs the traditional graphite felt material with a relatively low density and high porosity, maintaining the low fluid resistance feature of this material. Meanwhile, a thin layer of high-density graphite fiber material, such as the commercial graphite fiber-based carbon paper electrode material, is superimposed on both sides of the graphite felt material. The overall thickness of the composite electrode does not exceed 2 mm, which increases the specific surface area for electrode reaction and reduces the electrode thickness. Alternatively, the surface of the graphite fiber-based carbon paper material can be further modified by depositing a layer of graphite powder with a thickness of less than 100 μm to further increase the specific surface area for electrode reaction at localized positions on the outer surface of the electrode. The graphite fiber or graphite powder material used in this disclosure requires standard graphitization processing, with a heat treatment temperature not lower than 2000° C. To increase the activation functional groups for electrochemical redox reactions and enhance electrode performance, further processing of the electrode in an oxygen-containing environment at a high temperature of 400˜500° C., or other chemical treatment methods, are also acceptable.

The material composite methods for the electrode structures in FIGS. 1(b) and 1(c) can involve superimposing multiple layers of graphite fiber-based carbon paper and graphite fiber carbon cloth with different densities, thicknesses, and structures, and then combining them through puncturing, bonding, or external mechanical packaging. Alternatively, during the initial weaving of PAN-based fibers, a special weaving process can be used to create an asymmetric structure. After carbonization and graphitization treatments, surface modification can be performed through thermal oxidation or other surface treatment methods. The composite structures and composite methods described in this disclosure enable the electrode structure to form a thin asymmetric electrode structure. In addition, the effective area of the composite electrode structure described in this disclosure is greater than 200 cm², and within the effective area, the thickness of each layer as well as the composite thickness tolerance should be controlled within 5% to achieve relatively uniform electrode performance.

### Embodiment 2: A Membrane-Electrode Assembly Employing a Composite Electrode Structure

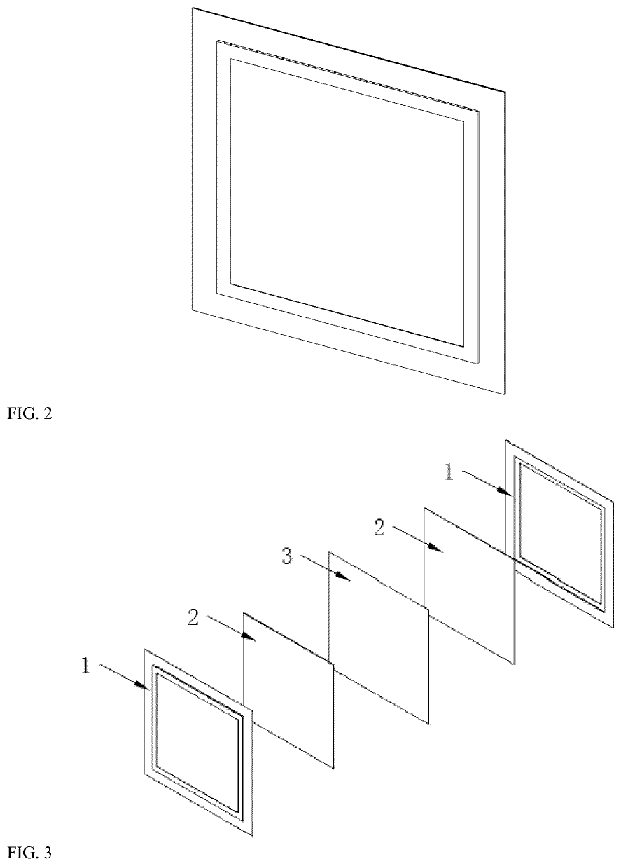

The above-mentioned composite binding method using external mechanical packaging to superimpose multiple layers of materials includes puncturing or bonding connections between multiple layers of electrode materials, and mainly refers to the structural relationship among the electrode, the membrane, and the electrode overall. FIG. 2 is the membrane-electrode assembly structure provided by this disclosure, and FIG. 3 is the frame laminated structure of the above-mentioned membrane-electrode assembly. This structure sequentially includes a plastic frame 1, a composite electrode 2, an ion exchange membrane 3, another composite electrode 2, and another plastic frame 1 in one direction, and these five components are formed by thermo-compression compounding.

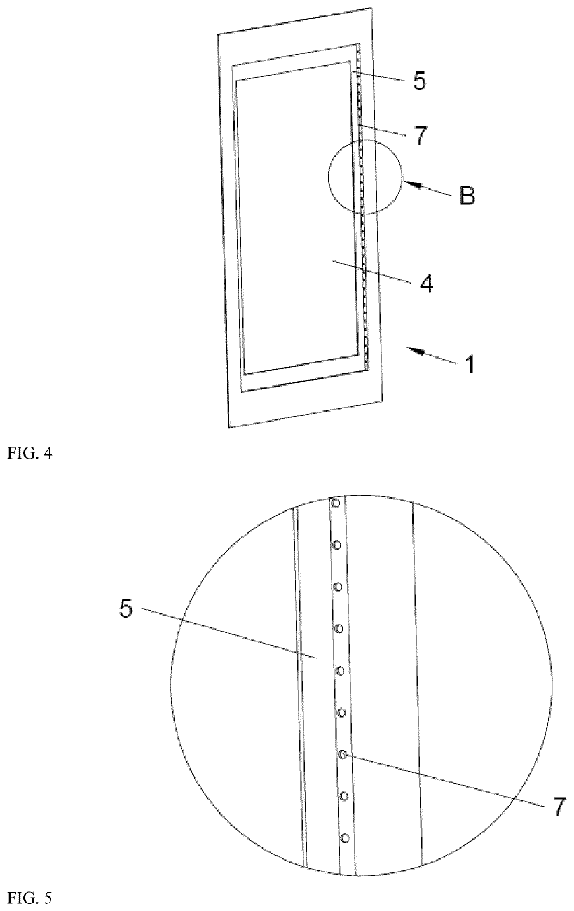

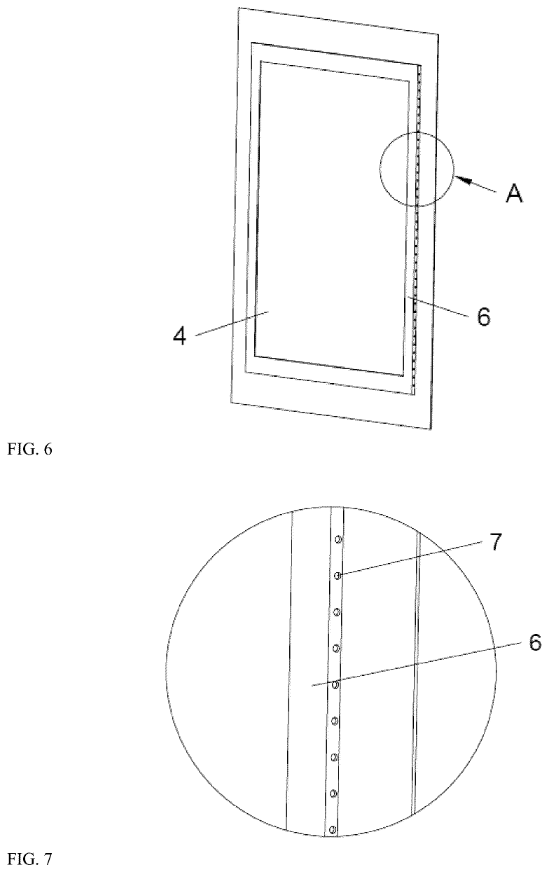

FIGS. 3 to 7 show the structure of a membrane-electrode assembly with an electrode thickness of 1 to 2 mm. The middle of the plastic frame 1 is provided with an opening 4, and a groove 5 is formed around the opening 4 on the inner side end of the plastic frame 1. An annular convex plate portion 6 is integrally formed at the outer side end of the plastic frame 1 near the opening 4, and a plurality of flow holes 7, which communicate with the groove 5, are provided on two opposite sides of the annular convex plate portion 6. This design ensures that the liquid passing through the electrode is more uniform. The material of the plastic frame 1 is typically a PE, PP, or PVDF engineering plastic film, but is not limited to these. The material is required to be easily fused by heating at a certain temperature and have good corrosion resistance, and is not easy to damage by prolonged contact with the electrolyte solution. The purpose of setting the flow holes 7 in this disclosure is to assist in liquid flow and reduce fluid resistance, allowing part of the fluid to flow through the voids in the electrode material. The electrolyte of the flow battery flows through the flow channels 11 to the flow holes 7, and then flows through the flow holes 7 to the composite electrode 2, ensuring more uniform distribution of the electrolyte within the electrode. When the electrode is thicker, the flow holes 7 are even more conducive to uniform fluid distribution in regions of the electrode that are not in contact with the flow channels 11.

In some embodiments, for a composite electrode having a larger thickness, for example, greater than 0.3 mm and less than 2 mm, a groove 5 is formed at an inner side end of the plastic frame 1, and an annular convex plate portion 6 is integrally formed at an outer side end of the plastic frame 1, and a plurality of flow holes 7 in communication with the groove 5 are formed at opposite sides of the annular convex plate portion 6. Whereas for the composite electrode 2 having a smaller thickness, for example, not greater than 0.3 mm, since the electrode itself is thinner, resulting in better electrode activity, the plastic frame 1 adopts a flat plate-type annular structure without a flow hole.

In thermo-compression compounding, the edge size of the ion exchange membrane is greater than the outer edge size of the composite electrode, the inner edge of the plastic frame is smaller than the outer edge of the composite electrode, preferably, the inner edge of the composite electrode presses against the outer edge of the composite electrode by at least 10 mm, and the outer edge size of the plastic frame is greater than the edge size of the ion exchange membrane. Specifically, to ensure good scaling, no leakage, and firm fixation, the membrane material is designed to be 5 to 15 mm greater than the edge of the electrode. The inner edge of the plastic frame presses on the outer edge of the electrode material for 10 mm or above, and the outer size of the plastic frame is 5 to 20 mm greater than the membrane material. This allows the plastic frame to directly compress the membrane during thermal compounding, while the edges of the two plastic frames are completely fused together, making the structure firmer. The sealing line can be positioned in the overlapping area between the plastic frame and the membrane, providing a sufficient sealing area. After the components are compositely bonded together using a specific thermal bonding process, the thickness tolerance of the entire effective area should be controlled within 10%.

The membrane mentioned in this disclosure is not a porous inert membrane material that relies on void structures in the membrane to transport ions and media, but instead utilizes a proton or anion exchange membrane that can selectively allow protons or anions to pass through while blocking other high-valent cations. Generally, such proton or anion exchange membrane material can include one or a combination of any of a perfluorosulfonic acid membrane, a non-perfluorosulfonic acid membrane, a hydrocarbon proton exchange membrane, a quaternized anion exchange membrane, an amphoteric ion exchange membrane with a modified polymeric material as the base material, or other modified ion exchange membranes. Wherein, the thickness tolerance of the proton or anion exchange membrane material within the effective area should be controlled within 10%.

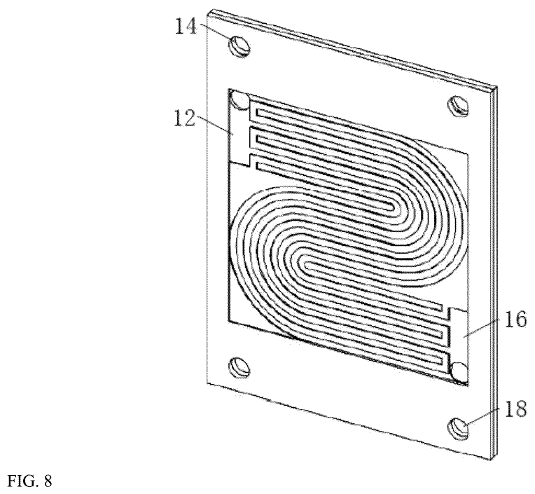

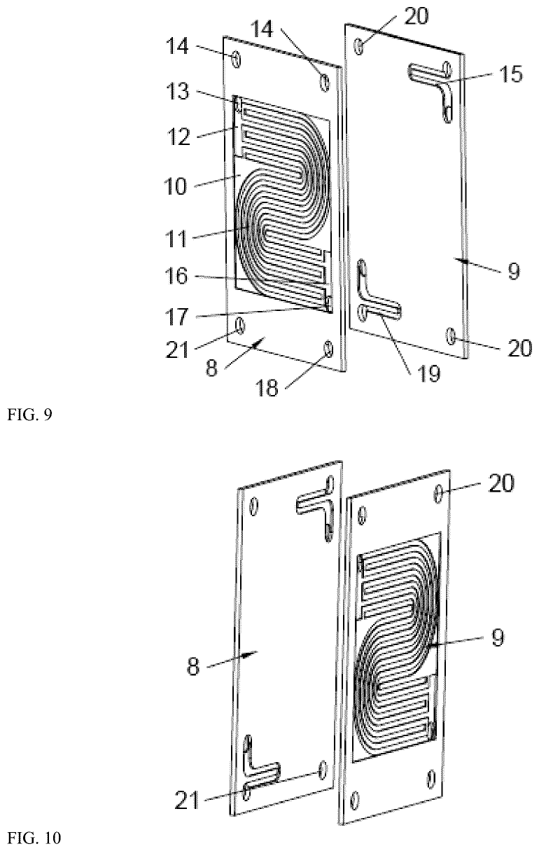

FIGS. 8-10 show the bipolar plate structure. The bipolar plate 26 includes a first polar plate 8 and a second polar plate 9; an outer side end of the first plate 8 is provided with a first electrode slot 10, the first electrode slot 10 is provided with first flow channels 11, at one end of the first flow channels 11, the first electrode slot 10 is provided with a flow field electrolyte outlet 12 communicating with the first flow channels 11, the flow field electrolyte outlet 12 is in a trough-like structure, a first drainage hole 13 is formed on the flow field electrolyte outlet 12, electrolyte-outlet-sharing through holes 14 are formed on the first polar plate 8 at a side of the flow field electrolyte outlet 12, and a first flow guiding channel 15 is formed on an inner side end of the first polar plate 8 to connect the first drainage hole 13 and the electrolyte-outlet-sharing through hole 14, and the first flow guiding channel 15 has a U-shape; the first electrode slot 10 is provided with a flow field electrolyte inlet 16 communicating with the first flow channels 11 at the other end of the first flow channels 11, the flow field electrolyte outlet 12 is in a trough-like structure, the flow field electrolyte inlet 16 is provided with a second drainage hole 17, an electrolyte-inlet-sharing through hole 18 is formed on the first polar plate 8 at a side of the flow field electrolyte inlet 16, and a second flow guiding channel 19 is formed on an inner side end of the first polar plate 8 to connect the second drainage hole 17 and the electrolyte-inlet-sharing through hole 18, and the second flow guiding channel 19 has a U-shape. The second polar plate 9 has the same structure as the first polar plate 8, and both the first polar plate 8 and the second polar plate 9 are superimposed such that the inner side ends of both abut each other and are arranged in a mirror-image configuration, thereby forming a bipolar plate 26 structure. At the same time, the second polar plate 9 is provided with first through holes 20 which are matched with the electrolyte outlet-sharing through holes 14 on the first electrode plate, and the first polar plate 8 is provided with a second through hole 21 which is matched with the electrolyte outlet-sharing through hole 14 on the second electrode plate.

FIG. 12 shows the combination of the membrane-electrode assembly (with the electrode thickness of 1-2 mm) and the bipolar plate. The membrane-electrode assembly embeds the electrode into the electrode groove, and the electrolyte fluid flows from the inlet shared channel to the flow-restricting channel on the back of the flow field plate, then flows towards the serpentine flow field inlet, and finally is distributed into multiple flow channels. As the electrolyte flows through the flow channels, it can also enter the voids of the electrode material through the flow hole on the plastic frame. The flow channels of the flow field plate can be set as serpentine cross-flow channels. When the electrolyte flows in the flow channels, the flow channel at the inlet is sealed at the end, thus forcing the fluid to flow into the voids of the composite electrode, and then into the adjacent flow channel with an open outlet, and finally flows out to the fluid shared channel. Wherein, the pressure drop across the battery needs to be controlled within 100 kPa, and the flow rate and concentration of the electrolyte solution passing through should meet the material supply stoichiometric ratio requirements of the redox reaction.

For thick electrodes with a thickness of 1-2 mm, a plate frame composite structure with fluid inlet and outlet holes is adopted. Due to the relatively thick electrode, in order to reduce fluid resistance, it is necessary to use a bipolar plate with a partial flow field function structure to cooperate with the electrode, as shown in FIG. 8. The bipolar plate with the partial flow channel function has an electrode slot on one side of the flow field, and the flow channels are relatively shallow, with the purpose of allowing only part of the fluid to flow through.

For thin electrodes with a thickness≤1 mm, the membrane-electrode assembly employs a plastic frame without flow channel holes. Due to the small porosity and significantly increased fluid resistance within the electrode, a specially designed bipolar plate with a full flow field functional structure is required, as shown in FIG. 14. The bipolar plate with the full flow channel function has a flow field without an electrode slot, and the flow channels are relatively deep. The electrolyte fluid first flows into the serpentine cross-flow channels, and then is forced into the voids of the electrode material, and then flows out into adjacent flow channels. Other flow processes and forms are similar to those described previously.

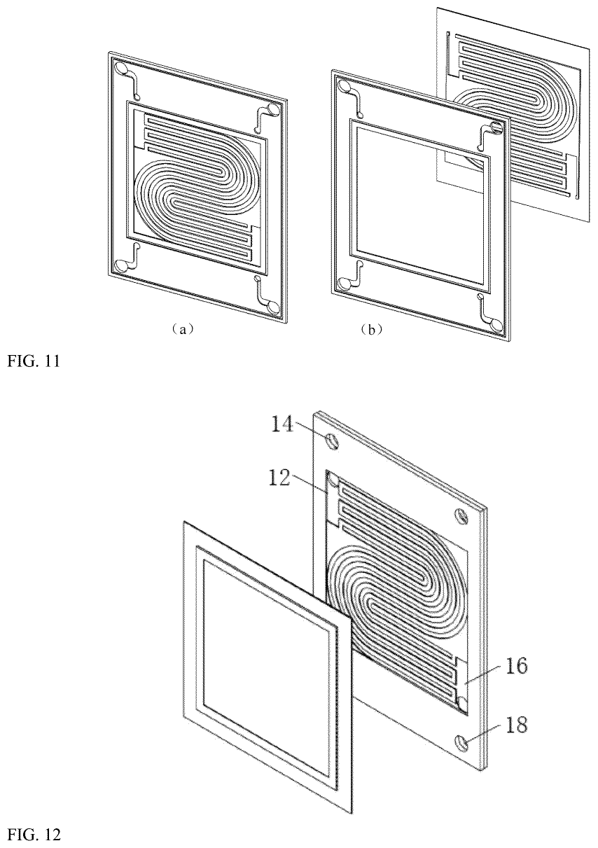

The bipolar plate material is usually a graphite composite material with good corrosion resistance. The bipolar plate can be an integral structure or a separate structure with a graphite flow field plate embedded in a plastic frame, as shown in FIG. 11. The material of the plastic frame can be a heat-composite plastic film frame material, such as PP, PVDF, CPVC, etc. The PE material is not used temporarily due to its poor temperature resistance.

### Embodiment 3: A Single Cell or Flow Battery Stack Employing a Membrane-Electrode Assembly

For the flow battery stack, or single cell, the flow battery is provided with a flow field plate, or bipolar plate, which is matched to the composite electrode described above, and the liquid is uniformly mirrored onto the electrode through the flow channels in the bipolar plate.

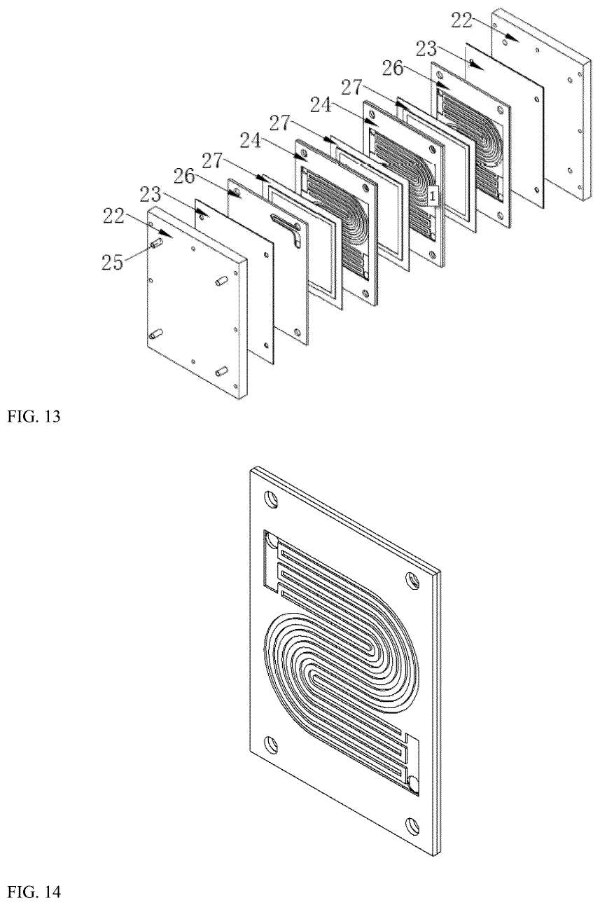

When a plurality of cells are superimposed together, a battery stack is formed. FIG. 13 shows a battery stack composed of three cells, with the order of components as follows:
(1) positive electrode-fixed end plate 22;
(2) positive electrode-current collecting plate 23;
(3) first-bipolar plate 26;
(4) first-membrane-electrode assembly 27;
(5) positive electrode-end flow field plate 24;
(6) second-membrane-electrode assembly 27;
(7) negative electrode-end flow field plate 24;
(8) third-membrane-electrode assembly 27;
(9) second-bipolar plate 26;
(10) negative electrode-current collecting plate 23; and
(11) negative electrode-fixed end plate 22.

When the two bipolar plates 26 and the second and third membrane-electrode assemblies in the battery stack shown in FIG. 13 are removed, it is simplified to a single cell with only one cell. The cells in the battery stack are superimposed to form a structure where they are connected in series in circuit and parallel in fluid supply. Therefore, the flow field plate between two cells is referred to as the bipolar plate. The present disclosure does not provide a detailed description of the scaling among the positive and negative flow field plates, the membrane-electrode assemblies, and the bipolar plates, but those skilled in the field should be aware that sealing is not limited to mechanical sealing using gaskets, adhesive sealing, or hybrid sealing methods.

The following reference examples and examples based on the present disclosure further elaborate and compare the disclosure, but those skilled in the art should be aware that the disclosure is not limited to this. In other words, the disclosure is not limited to the embodiments of the disclosure described above or the following examples, and various changes can be made within the scope of the technical matters of the disclosure.

### Reference Example—a Conventional Graphite Felt Electrode

The graphite felt electrode has a thickness of 5.5 mm, a porosity of 95%, a specific surface area of approximately 2 m²/g, a bulk density of 0.12 g/cm³, and an effective area of 800 cm². The electrolyte solution is a mixture of FeCl₂, CrCl₃, and 2M HCl, with a measured solution conductivity of 0.2 S/cm. The membrane material used is Nafion 115, with a thickness of 125 μm and a proton conductivity of 13.4 mS/cm. The contact resistance between the carbon felt electrode and the bipolar plate is approximately 20.2 mΩ·cm², based on measurements in referenced literature. When SoC=90%, the reaction temperature is 65° C., the current density is 70 mA/cm², and the overpotential of the battery is about 300 mV considering the reaction in which Cr³⁺ is reduced to Cr²⁺ upon charging. The porous void surface reaction rate constant k′ and reaction polarization overpotential (E−E⁰) under this condition are calculated to be 5.54×10⁻⁹ and 41 mV, respectively, according to the foregoing equation.

### Example 1—Graphite Felt Superimposed on Both Sides with Carbon Paper

The GDL 10AA carbon paper from SGL Carbon, which is 0.4 mm thick, is superimposed on both sides of the 2 mm-thick graphite felt electrode in a single layer to form a 3-layer composite electrode. The total electrode thickness is 2.8 mm, the porosities are 95% and 95.5%, the specific surface areas are approximately 20 and 2 cm²/g, the bulk densities are 0.24 and 0.12 g/cm³, a geometric active area is 800 cm², and the electrolyte solution remains a mixture of FeCl₂, CrCl₃, and 2M HCl. The membrane material used is still Nafion 115. The contact resistance between the carbon paper electrode and the bipolar plate is approximately 0.2 mΩ·cm², based on measurements described in reference literature. When SoC=90%, the reaction temperature is 65° C., considering the reaction in which Cr³⁺ is reduced to Cr²⁺ upon charging, it is calculated that when the overpotential of the battery reaches 300 mV, the current density reaches 412 mA/cm². The voltage efficiency is approximately 84%, the coulombic efficiency is 99%, and the charge-discharge energy conversion efficiency of the battery system is approximately 83.4%. Therefore, when a 3-layer composite carbon paper-graphite felt electrode is used, the battery performance is somewhat improved.

### Example 2—Graphite Felt Coated on Both Sides with Graphite Powder

The 2 mm-thick graphite felt electrode material of Example 1 is adopted, graphite powder is coated on both sides of the graphite felt electrode to form a 3-layer composite electrode. It is assumed that the thickness of the graphite powder is 100 μm, in general, the specific surface area of the graphite powder is approximately 100 times that of the graphite felt, which is 200 cm²/g, and the bulk density remains unchanged at 0.2 g/cm³. The geometric active area of the electrode is maintained at 800 cm². The electrolyte solution remains a mixture of FeCl₂, CrCl₃, and 2M HCl, and the membrane material used is still Nafion 115. The contact resistance between the composite electrode and the bipolar plate should decrease, which is estimated to be 0.1 mΩ·cm². Therefore, when SoC=90% and the reaction temperature is 65° C., considering the reaction in which Cr³⁺ is reduced to Cr²⁺ upon charging, after calculations similar to the reference example, it is obtained that the overpotential of the battery is 245 mV, and the current density is 492 mA/cm². This shows a further improvement in battery performance. Furthermore, the load electrode structure of the multilayer graphite powder-carbon felt-graphite powder can be optimized to further enhance the performance of the flow battery.

### Example 3—Carbon Paper Coated on Both Sides with Graphite Powder

Another GDL 39AA carbon paper from SGL Carbon, having a thickness of 0.28 mm, is coated on both sides with graphite powder to form a 3-layer composite electrode. It is assumed that the thickness of the graphite powder is 100μιη, in general, the specific surface area of the graphite powder is approximately 10 times that of the carbon paper, i.e. 200 cm²/g, and the bulk density is assumed to remain unchanged at 0.2 g/cm³. The electrode thus formed is a 3-layer composite electrode, and the geometric active area of the electrode is maintained at 800 cm². The electrolyte solution remains a mixture of FeCl₂, CrCl₃, and 2M HCl. The membrane material used is still Nafion 115. The contact resistance of the carbon paper electrode to the bipolar plate should be reduced, estimated to be 0.1 mΩ·cm². When SoC=90%, the reaction temperature is 65° C., considering the reaction in which Cr³⁺ is reduced to Cr²⁺ upon charging, after calculations similar to the reference example, it is obtained that the overpotential of the battery is 255 mV, and the current density is 631 mA/cm². This shows a further improvement in battery performance. Furthermore, the load electrode structure of the multilayer carbon powder-carbon paper-carbon powder can be optimized to further enhance the performance of the flow battery.

### Example 4—Graphite Powder Coating after Superposition of Carbon Paper

Another GDL 39AA carbon paper from SGL Carbon, having a thickness of 0.28 mm, is, coated with graphite powder on a single side, an electrode structure with carbon paper-carbon paper adjacent superposition and graphite powder outside is adopted. It is assumed that the thickness of the graphite powder is 100 μm, in general, the specific surface area of the graphite powder is approximately 10 times that of the carbon paper, i.e. 200 cm²/g, and the bulk density is assumed to remain unchanged at 0.2 g/cm³. The electrode thus formed is a 4-layer composite electrode, maintaining a geometric effective area of the electrode of 800 cm². The electrolyte solution remains a mixture of FeCl₂, CrCl₃, and 2M HCl. The membrane material used is still Nafion 115. The contact resistance of the carbon paper electrode to the bipolar plate should be reduced, estimated to be 0.1 mΩ·cm². When SoC=90%, the reaction temperature is 65° C., considering the reaction in which Cr³⁺ is reduced to Cr²⁺ upon charging, after calculations similar to the reference example, it is obtained that the overpotential of the battery is 257 mV, and the current density is 761 mA/cm². This shows a further improvement in battery performance. Furthermore, the load electrode structure of the multilayer carbon powder-carbon paper-carbon paper-carbon powder can be optimized to further enhance the performance of the flow battery.

### Example 5—Graphite Powder Coating after Superposition of Carbon Paper on Both Sides of Graphite Felt

Another GDL 39AA carbon paper from SGL Carbon, having a thickness of 0.28 mm, is, coated with graphite powder on a single side, and an intermediate sandwich is a 2 mm-thick graphite felt in Example 1 to form a 5-layer composite electrode. It is assumed that the thickness of the graphite powder is 100 μm, in general, the specific surface area of the graphite powder is approximately 10 times that of the carbon paper, i.e. 200 cm²/g, and the bulk density is assumed to remain unchanged at 0.2 g/cm³. The electrode thus formed is a 5-layer composite electrode, maintaining a geometric effective area of the electrode of 800 cm². The electrolyte solution remains a mixture of FeCl₂, CrCl₃, and 2M HCl. The membrane material used is still Nafion 115. The contact resistance of the carbon paper electrode to the bipolar plate should be reduced, estimated to be 0.1 mΩ·cm². When SoC=90%, the reaction temperature is 65° C., considering the reaction in which Cr³⁺ is reduced to Cr²⁺ upon charging, after calculations similar to the reference example, it is obtained that the overpotential of the battery is 278 mV, and the current density is 792 mA/cm². This shows a further improvement in battery performance. Furthermore, the load electrode structure of the multilayer carbon powder-carbon paper-carbon felt-carbon paper-carbon powder can be optimized to further enhance the performance of the flow battery.

The above are only preferred embodiments of the present disclosure, the protection scope of the present disclosure is not limited to the above examples, and the technical solutions falling under the idea of the present disclosure belong to the protection scope of the present disclosure. It should be noted that numerous modifications and adaptations may occur to those skilled in the art without departing from the principles of the present disclosure, and such modifications and adaptations should be considered to be within the protection scope of the present disclosure.

1. A composite electrode structure, the composite electrode is formed by compounding electrode materials which are non-uniform in direction and are of various materials into an asymmetric structure.

2. The composite electrode structure according to claim 1, wherein the electrode materials comprise graphite felt and graphite fiber-based carbon paper, the graphite felt and graphite fiber-based carbon paper being laminated.

3. The composite electrode structure according to claim 1, wherein the electrode materials comprise graphite felt or graphite fiber-based carbon paper, in both sides of the graphite felt or graphite fiber-based carbon paper, an outer surface layer on at least one side is provided with a graphite powder layer, and the graphite powder layer is formed by coating deposition.

4. The composite electrode structure according to claim 1, wherein the electrode material comprises graphite felt and graphite fiber-based carbon paper, the graphite felt and graphite fiber-based carbon paper being laminated, and in both sides of a structure obtained by laminating the two, a graphite powder layer is arranged in an outer surface layer of at least one side, the graphite powder layer being formed by coating deposition.

5. The composite electrode structure according to claim 2, wherein the graphite felt has a one-layer or multi-layer structure and the graphite fiber-based carbon paper is a one-layer or multi-layer structure.

6. The composite electrode structure according to claim 3, wherein the graphite felt has a thickness of less than 2 mm, the graphite fiber-based carbon paper has a thickness of less than 0.4 mm, the graphite powder layer has a thickness of less than 100 μm, and a composite electrode structure has a total thickness of not greater than 2 mm.

7. The composite electrode structure according to claim 1, wherein the composite electrode structure is treated at a high temperature ranging from 400° C. to 500° C. in the presence of oxygen.

8. A membrane-electrode assembly, wherein the assembly comprises a plastic frame (1), the composite electrode (2) according to claim 1, an ion exchange membrane (3), the composite electrode (2), and a plastic frame (1) in order in one direction, and the five are formed by thermo-compression compounding.

9. The membrane-electrode assembly according to claim 8, wherein,
for the composite electrode (2) having a thickness of greater than 0.3 mm and less than 2 mm, a groove (5) is formed at an inner side end of the plastic frame (1), an annular convex plate portion (6) is integrally formed at an outer side end of the plastic frame (1), and a plurality of flow holes (7) communicating with the groove (5) are formed at opposite sides of the annular convex plate portion (6); and
for the composite electrode (2) having a thickness of not greater than 0.3 mm, the plastic frame (1) has a flat plate-type annular structure.

10. The membrane-electrode assembly according to claim 8, wherein an edge size of the ion exchange membrane (3) is greater than an outer edge size of the composite electrode (2), an inner edge of the plastic frame (1) is smaller than an outer edge of the composite electrode (2) and an outer edge size of the plastic frame (1) is greater than the edge size of the ion exchange membrane (3).

11. The membrane-electrode assembly according to claim 8, wherein the ion exchange membrane material comprises one or a combination of any of a perfluorosulfonic acid membrane, a non-perfluorosulfonic acid membrane, a hydrocarbon proton exchange membrane, a quaternized anion exchange membrane, an amphoteric ion exchange membrane with a modified polymeric material as the base material.

12. A flow battery stack or single cell, comprising the membrane-electrode assembly according to claim 8.

13. The flow battery stack or single cell according to claim 12, wherein a flow field plate or bipolar plate that is matched with the composite electrode (2) is provided in a flow battery, a liquid being uniformly mirrored onto the electrode through flow channels on the flow field plate or bipolar plate.

14. The flow battery stack or single cell according to claim 12, wherein,
for the composite electrode structure having a thickness of 1-2 mm, the flow field plate or bipolar plate has a partial flow field functional structure with shallow flow channels and contains an electrode slot, allowing an electrolyte fluid to partially flow through the flow channels; and
for the composite electrode structure having a thickness of not greater than 1 mm, the flow field plate or bipolar plate has a full flow field functional structure with deep flow channels and does not contain an electrode slot, allowing an electrolyte fluid to wholly flow through the flow channels.
